(19) United States
(12) Patent Application Publication
(10) Pub. No.: US 2026/0031600 A1
(43) Pub. Date: Jan. 29, 2026

(54) CABINET ASSEMBLY OF ENERGY STORAGE APPARATUS, AND ENERGY STORAGE APPARATUS HAVING SAME

(71) Applicant: Sungrow Power Supply Co., Ltd., Hefei (CN)

(72) Inventors: Peng Wang, Hefei (CN); Zhongyuan Li, Hefei (CN)

(73) Assignee: Sungrow Power Supply Co., Ltd., Hefei (CN)

(21) Appl. No.: 19/101,155

(22) PCT Filed: May 22, 2023
(86) PCT No.: PCT/CN2023/095471

§ 371 Date: Feb. 4, 2025

(30) Foreign Application Priority Data
Sep. 14, 2022 (CN) 202222448522.0

(51) Int. Cl. H02B 1/20; A62C 3/16; H01M 50/251; H01M 50/298; H02B 1/30; H02B 1/32

(52) U.S. Cl. CPC H02B 1/20; A62C 3/16; H01M 50/251; H01M 50/298; H02B 1/306; H02B 1/32

(57) ABSTRACT

A cabinet assembly and an energy storage apparatus are provided. The cabinet assembly includes a body having a first chamber and a second chamber, a first wiring assembly fixed to an inner wall of the body and having a first wiring space, a second wiring assembly fixed to the inner wall of the body and having a second wiring space for guiding wiring of a communication cable, and a third wiring space located in the second chamber. The first wiring space has a first wiring hole located in the first chamber, and a fire-fighting cable is adapted to be electrically connected to a fire-fighting device through the first wiring hole. The first wiring space and the second wiring space are in communication with the third wiring space, and the fire-fighting cable and the communication cable are electrically connected to an electrical element.

This application claims the priority to Chinese Patent Application No. 202222448522.0, titled “CABINET ASSEMBLY OF ENERGY STORAGE APPARATUS, AND ENERGY STORAGE APPARATUS HAVING SAME”, and filed with the China National Intellectual Property Administration on Sep. 14, 2022, which is incorporated herein by reference in its entirety.

### FIELD

The present application relates to the technical field of energy storage systems, and in particular to a cabinet assembly of an energy storage apparatus and an energy storage apparatus having the cabinet assembly.

### BACKGROUND

In the related technologies, large liquid-cooled outdoor cabinets usually need wiring between boxes. However, in traditional wiring, open wires are mainly used to run in the boxes. For the open wiring in the liquid-cooled outdoor cabinets, a fire is probably caused once the surface of wire is damaged, resulting in poor safety; moreover, too many open wires will affect the neat and aesthetic appearance of the liquid-cooled outdoor cabinets.

### SUMMARY

The present application aims to solve at least one of the technical problems existing in the prior art. To this end, an object of the present application is to provide a cabinet assembly of an energy storage apparatus and an energy storage apparatus having the cabinet assembly. The cabinet assembly according to the present application can realize the concealed wiring of open wires, to avoid the risks caused by failure of the open wires.

The present application also provides an energy storage apparatus having the cabinet assembly.

The cabinet assembly according to the present application includes: a main body, where a first chamber for accommodating a battery and a second chamber for accommodating an electrical element are provided in the main body; a first wiring assembly, which is fixed to an inner wall of the main body, where a first wiring space for guiding wiring of a fire-fighting cable is provided in the first wiring assembly, the first wiring space is provided with a first wiring hole located in the first chamber, and a fire-fighting device is provided on the first wiring assembly and electrically connected to the fire-fighting cable through the first wiring hole; a second wiring assembly, which is fixed to the inner wall of the main body, where a second wiring space, for guiding wiring of a communication cable configured to be electrically connected to the battery, is provided in the second wiring assembly; and a third wiring space, which is located in the second chamber, where the first wiring space and the second wiring space are respectively in communication with the third wiring space, and the fire-fighting cable and the communication cable are configured to be respectively electrically connected to the electrical element. The fire-fighting cable is routed from the first wiring space and the third wiring space to the second chamber to be electrically connected to the electrical element, and the communication cable is routed from the second wiring space and the third wiring space to the second chamber to be electrically connected to the electrical element.

According to the cabinet assembly of the present application, the first wiring space and the second wiring space are provided on the inner wall of the main body, and the third wiring space is located in the second chamber, which simplifies the overall wire arrangement, such that the concealed wiring of open wires can be realized, to avoid the risks caused by the failure of the open wires.

According to some embodiments of the present application, the first wiring assembly includes: a first accommodating member, where the first wiring space having a placement opening is located in the first accommodating member, the fire-fighting cable is configured to be placed in the first wiring space through the placement opening, and the first accommodating member is fixed to the main body; and a first covering member, which is arranged at the first accommodating member to cover the placement opening.

According to some embodiments of the present application, a first partition plate is provided in the first accommodating member to define a first wiring slot and a second wiring slot, where the first wiring slot is configured for placing an information transmission part of the fire-fighting cable, and the second wiring slot is configured for placing a power transmission part of the fire-fighting cable.

According to some embodiments of the present application, a first positioning member for positioning the fire-fighting cable is provided in the first wiring space.

According to some embodiments of the present application, the second wiring assembly includes: a first plate, which is fixed to the main body; and a second plate, where a part of the second plate is connected to the first plate, another part of the second plate is located at one side of the first plate; and the second wiring space is located between the first plate and the second plate.

According to some embodiments of the present application, a second partition plate is provided on the first plate to define multiple third wiring slots.

According to some embodiments of the present application, the first plate and/or the second plate is provided with a second positioning member for positioning the communication cable.

According to some embodiments of the present application, the second positioning member is located at one side of the second partition plate in a length direction.

According to some embodiments of the present application, the first wiring assembly and the second wiring assembly are both located at a top of the first chamber.

According to some embodiments of the present application, the third wiring space is located close to a corner of a wall of the second chamber.

According to some embodiments of the present application, the main body includes an outer housing and an inner plate, where the inner plate is fixed to an inner surface of the outer housing, and the inner plate defines an inner wall of the second chamber; and the third wiring space is defined between the inner plate and the inner surface of the outer housing.

According to some embodiments of the present application, a third partition plate is provided on the inner surface of the outer housing to define multiple fourth wiring slots.

According to some embodiments of the present application, the inner surface of the outer housing is provided with a third positioning member for positioning a cable.

An energy storage apparatus according to another embodiment of the present application is briefly described below.

The energy storage apparatus according to the present application includes: the cabinet assembly according to any one of the above embodiments; an electrical element placed in the second chamber; a battery located in the first chamber, where the communication cable which is connected to the battery is routed along the second wiring space and the third wiring space to be electrically connected to the electrical element; and a fire-fighting device, which is located in the first chamber, where the fire-fighting cable electrically connected to the fire-fighting device is routed along the first wiring space and the third wiring space to be electrically connected to the electrical element. Since the energy storage apparatus according to the present application has the cabinet assembly of the above embodiment, the overall wire arrangement of the energy storage apparatus is simpler, the open wiring can be concealed, and thereby reducing the risk caused by the failure of the open wires.

According to some embodiments of the present application, the energy storage apparatus further includes an external power cable, where one end of the external power cable extends out of the second chamber, and the external power cable is routed along the third wiring space to be electrically connected to the electrical element.

In summary, the first wiring space, the second wiring space and the third wiring space are provided in the cabinet assembly according to the present application, so that the overall wire arrangement can be simplified, and the open wires can be concealed, so the risks caused by the failure of the open wires are avoided. The first wiring space is closed by the first covering member, which has a protective effect and maintains a good overall appearance of the cabinet assembly. Moreover, the first partition plate, the second partition plate, and the third partition plate are respectively provided in the first wiring space, the second wiring space, and the third wiring space to define multiple wiring slots for isolating cables having different functions. The first positioning member, the second positioning member and the third positioning member are also provided in the first wiring space, the second wiring space and the third wiring space respectively so as to cooperate with the cable ties to fix the corresponding cables, thereby preventing the cable from playing. By arranging the third wiring space in the wall, cables can be wired to run through the wall, so as to reduce the space occupied by the additional wire conduit, to avoid affecting the overall appearance of the cabinet assembly.

Additional aspects and advantages of the present application will be partly given in the following description, and the part will become apparent from the following description, or be learned by the practice of the present application.

### BRIEF DESCRIPTION OF THE DRAWINGS

The above and/or additional aspects and advantages of the present application will become apparent and easy to understand from the description of the embodiments below in conjunction with the accompanying drawings.

FIG. 1 is a schematic view showing the structure of a cabinet assembly according to an embodiment of the present application;

FIG. 2 is a side view of the cabinet assembly according to the embodiment of the present application;

FIG. 3 is an enlarged view of portion A in FIG. 2;

FIG. 4 is a schematic view showing the structure of a first wiring assembly according to an embodiment of the present application;

FIG. 5 is a schematic view showing the structure of a second wiring assembly according to the embodiment of the present application;

FIG. 6 is an enlarged view of portion B in FIG. 5; and

FIG. 7 is a schematic view showing the structure of the second wiring assembly according to the embodiment of the present application.

Reference numerals:

| | | | |
|---|---|---|---|
| 1 | cabinet assembly, | 10 | first wiring assembly, |
| 11 | first covering member, | 12 | first accommodating member, |
| 13 | first positioning member, | 14 | first partition plate, |
| 15 | first wiring hole, | 16 | second wiring hole, |
| 20 | second wiring assembly, | 21 | first plate, |
| 22 | second plate, | 23 | second positioning member, |
| 24 | second partition plate, | 31 | third partition plate, |
| 32 | third positioning member, | 40 | main body. |

### DETAILED DESCRIPTION OF THE EMBODIMENTS

The embodiments of the present application are described below in detail. Examples of the embodiments are shown in the accompanying drawings, in which same or similar reference numerals refer to same or similar elements or elements having the same or similar functions throughout the accompanying drawings. The embodiments described below with reference to the accompanying drawings are exemplary, which are only used to explain the present application, and should not be understood as a limitation for the present application.

In the description of the present application, it should be understood that the orientations or positional relationships indicated by terms such as “central”, “longitudinal”, “lateral”, “length”, “width”, “thickness”, “upper”, “lower”, “front”, “rear”, “left”, “right”, “vertical”, “horizontal”, “top”, “bottom”, “inner”, “outer”, “clockwise”, “anticlockwise” and the like are based on the orientations or positional relationships shown in the accompanying drawings, and are merely for the convenience of describing the present application and simplifying the description, which do not indicate or imply that the device or element referred must be arranged in a particular orientation, or be constructed and operated in a particular orientation, and therefore should not be understood as a limitation for the present application.

In addition, the terms “first”, “second” and the like are only used for the purpose of description, and should not be understood as indicating or implying relative importance or implicitly indicating the number of the indicated technical features. Therefore, the feature defined by “first” or “second” may explicitly or implicitly include one or more of these features. In the description of the present application, “multiple/plurality of” means at least two, such as two, or three, etc., unless clearly defined otherwise.

In the present application, terms relating to “mount”, “link”, “connect” and “fix” should be understood broadly, unless otherwise explicitly specified and defined. For example, it may refer to fixed connection, detachable connection or integral formation; it may refer to mechanical connection, electrical connection or communicative connection; it may refer to direct connection or indirect connection through an intermediate medium; it may also refer to internal communication between two elements or interaction between two elements. For those skilled in the art, the specific meaning of the above terms in the present application may be understood in the light of specific circumstances.

In the present application, unless otherwise explicitly specified and limited, the first feature being “above” or “below” the second feature may include direct contact between the first and second features, and may also include that indirect contact between the first and second features through another feature between them. Furthermore, the first feature being “above”, “over” and “on” the second feature includes that the first feature is directly above and obliquely above the second feature, or simply indicates that the first feature is higher in horizontal height than the second feature. The first feature being “below”, “under” and “lower than” the second feature includes that the first feature is directly below and obliquely below the second feature, or simply indicates that the first feature is lower in horizontal height than the second feature.

In the related technologies, large liquid-cooled outdoor cabinets usually need wiring between boxes. However, in traditional wiring, open wires are mainly used to run in the boxes. For the open wiring in the liquid-cooled outdoor cabinets, a fire is probably caused once the surface of wire is damaged, resulting in poor safety; moreover, too many open wires will affect the neat and aesthetic appearance of the liquid-cooled outdoor cabinets.

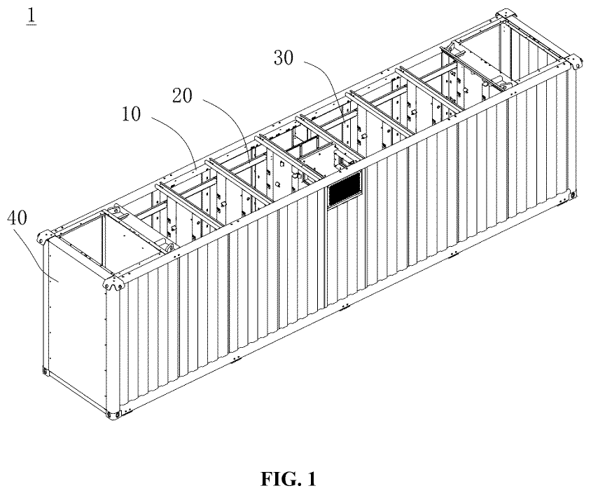

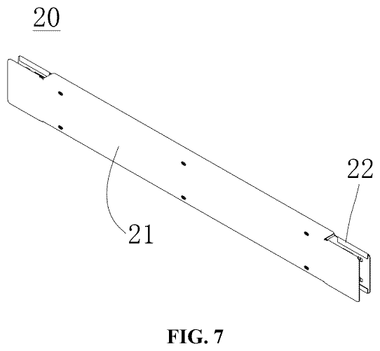

A cabinet assembly 1 of an energy storage apparatus according to an embodiment of the present application is described below with reference to FIG. 1 to FIG. 7.

As shown in FIG. 1, the cabinet assembly 1 according to the present application includes a main body 40, a first wiring assembly 10, a second wiring assembly 20, and a third wiring space. A first chamber for accommodating a battery and a second chamber for accommodating an electrical element are provided in the main body 40. The first wiring assembly 10 is fixed to an inner wall of the main body 40, a first wiring space for guiding wiring of a fire-fighting cable is provided in the first wiring assembly 10, the first wiring space is provided with a first wiring hole 15 located in the first chamber, and the fire-fighting cable is suitable to be electrically connected to a fire-fighting device through the first wiring hole 15. The second wiring assembly 20 is fixed to the inner wall of the main body 40, and a second wiring space, for guiding wiring of a communication cable configured to be electrically connected to the battery, is provided in the second wiring assembly. The third wiring space is located in the second chamber, the first wiring space and the second wiring space are respectively in communication with the third wiring space, and the fire-fighting cable and the communication cable are configured to be respectively electrically connected to the electrical element. Specifically, the fire-fighting device may be a smoke detector, a temperature detector, a combustible gas detector, a fire-fighting valve, a fire-fighting fan, and the like.

Specifically, the first chamber and the second chamber are formed in the main body 40 of the cabinet assembly 1, where the first chamber is configured to accommodate the battery, and the second chamber is configured to accommodate the electrical element. The first wiring assembly 10 is provided on the inner wall of the main body 40 of the cabinet assembly 1 and is provided with the first wiring space. It is necessary to arrange the fire-fighting cable separately, the fire-fighting cable passes through the first wiring hole 15 of the first wiring space to be electrically connected to the fire-fighting device, to realize fire-fighting wiring, so that additional fire-fighting wire conduits are no longer needed for the cabinet assembly 1. The second wiring assembly 20 is provided on the inner wall of the main body 40 of the cabinet assembly 1 and is provided with the second wiring space. In order to avoid interference between the communication cable and other cables, the second wiring space is separately provided, and the communication cable is routed in the second wiring space and is electrically connected to the battery. The first wiring space is configured to guide the wiring of the fire-fighting cable, and the second wiring space is configured to guide the wiring of the communication cable. The third wiring space is in communication with the first wiring space and the second wiring space respectively to guide the fire-fighting cable and the communication cable to the third wiring space; and since the third wiring space is located in the second chamber, the fire-fighting cable and the communication cable are routed into the third wiring space and are electrically connected to the electrical element in the second chamber.

Specifically, the main body 40 includes an outer housing and an inner partition plate, where the inner partition plate is provided in the outer housing to separate the first chamber and the second chamber from each other. The inner partition plate is provided with an avoiding hole to allow the first wiring space to be in communication with the third wiring space, and allow the second wiring space to be in communication with the third wiring space.

In the cabinet assembly 1 according to the present application, the first wiring space and the second wiring space are provided on the inner wall of the main body 40 and the third wiring space is located in the second chamber, which simplifies the overall wire arrangement, and thus the open wiring can be concealed, thereby reducing the risk caused by the failure of the open wires.

In some embodiments, as shown in FIG. 1, there are multiple first chambers, at least one of which is provided on each of both sides of the second chamber, the first wiring spaces in the first chambers located on the same side of the second chamber are in communication with each other, the second wiring spaces in the first chambers located on the same side of the second chamber are in communication with each other, so that the fire-fighting device in each first chamber is electrically connected to the electrical element via the fire-fighting cable, and the battery in each first chamber is electrically connected to the electrical element via the communication cable.

According to some embodiments of the present application, as shown in FIG. 4, the first wiring assembly 10 includes a first accommodating member 12 and a first covering member 11. The first accommodating member 12 is provided with the first wiring space having a placement opening, the fire-fighting cable is suitable to be placed in the first wiring space through the placement opening, and the first accommodating member 12 is fixed to the main body 40. The first covering member 11 is arranged at the first accommodating member 12 to cover the placement opening. Specifically, the first accommodating member 12 is fixed to the main body 40 and is provided internally with the first wiring space, the first wiring space is provided with the placement opening, the first covering member 11 can be fitted to the first accommodating member 12 to close the placement opening. When the placement opening is opened, the fire-fighting cable can be placed in the first wiring space through the placement opening, the first covering member 11 can close the placement opening after the fire-fighting cable is placed, to have a protective effect and keep a good overall appearance of the cabinet assembly 1. Compared with wiring by the round wire conduits in the prior art, the wiring of the fire-fighting cable is not limited by the first wiring space.

Further, as shown in FIG. 4, a side wall of the first wiring space is provided with a second wiring hole 16, and the fire-fighting cable extends out of the first wiring space through the second wiring hole 16 to extend into the third wiring space.

According to some embodiments of the present application, as shown in FIG. 4, a first partition plate 14 is provided in the first accommodating member 12 to define a first wiring slot and a second wiring slot, where the first wiring slot is suitable for placing an information transmission part of the fire-fighting cable, and the second wiring slot is suitable for placing a power transmission part of the fire-fighting cable. Specifically, in order to meet the requirements of fire-fighting design, the fire-fighting cable should be protected by an additional wire conduit or wire slot and cannot share the wire slot with other power cables, and wire slots for strong current and weak current needs to be separated. The first partition plate 14 is provided in the first accommodating member 12 to separate the first wiring space into the first wiring slot and the second wiring slot to isolate cables with different functions. The information transmission part of the fire-fighting cable is placed in the first wiring slot, and the power transmission part of the fire-fighting cable is placed in the second wiring slot.

According to some embodiments of the present application, as shown in FIG. 4, the first wiring space is provided internally with a first positioning member 13 for positioning the fire-fighting cable. Specifically, the first positioning member 13 is configured for fixing the fire-fighting cable in the first wiring space to prevent the fire-fighting cable from playing.

In some embodiments, the first covering member 11 is not limited to a sheet metal member being bent, and a surface of the first covering member 11 is pre-provided with a mounting hole for mounting a fire-fighting device such as a temperature-sensitive lamp, which is convenient for the arrangement of the wiring slots to reduce wiring perforation on site, and the first covering member 11 needs to be mounted on the first accommodating member 12 by bolts on site. The first accommodating member 12 is not limited to a sheet metal member being bent, and the first partition plate 14 is provided in the first accommodating member 12 for isolating cables with different functions, and a first positioning member 13 is provided in the first accommodating member 12 for fixing the cable. Compared with the wiring by the round wire conduits in the prior art, the wiring of the fire-fighting cable is not limited by the first wiring space.

In some embodiments, the first positioning member 13 includes multiple cable holes and multiple cable ties both protruding from the first partition plate 14, where the cable ties for binding the cable respectively run through the corresponding cable holes after the cable is bound, so as to fix the fire-fighting cable to the first partition plate 14, thereby preventing the fire-fighting cable from playing.

In some embodiments, the second wiring assembly 20 includes a second accommodating member and a second covering member. A second wiring space having a placement opening is provided in the second accommodating member, the communication cable is suitable to be placed in the second wiring space through the placement opening, and the second accommodating member is fixed to the main body 40. The second covering member is arranged at the second accommodating member to cover the placement opening. A partition plate is provided in the second accommodating member to define multiple wiring slots. Compared with the wiring by the round wire conduits in the prior art, the wiring of the communication cable is not limited by the second wiring space.

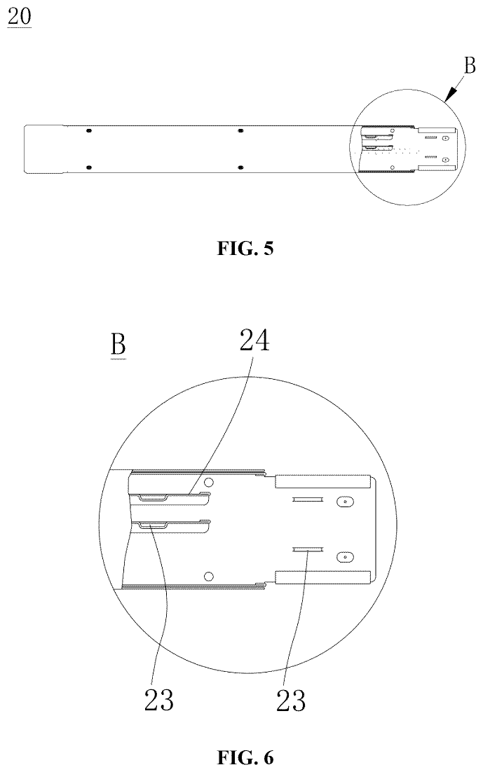

According to some embodiments of the present application, as shown in FIG. 5 to FIG. 7, the second wiring assembly 20 includes a first plate 21 and a second plate 22. The first plate 21 is fixed to the main body 40; a part of the second plate 22 is connected to the first plate 21, another part of the second plate 22 is located at one side of the first plate 21, and the second wiring space is located between the first plate 21 and the second plate 22. Specifically, the first plate 21 is fixed to the main body 40, and at least part of the second plate 22 is connected to the first plate 21 to define the second wiring space with the first plate 21. Compared with the wiring by the round wire conduits in the prior art, the wiring of the communication cable is not limited by the second wiring space. Of course, it may be understood that the structure of the second wiring assembly 20 is not limited thereto. The second wiring space may also be defined by bending a sheet metal member, and the wiring of the communication cable is not limited by the second wiring space.

According to some embodiments of the present application, as shown in FIG. 5 to FIG. 7, a second partition plate 24 is provided on the first plate 21 to define multiple third wiring slots. Specifically, the second partition plate 24 is provided on the first plate 21 to separate the second wiring space into multiple third wiring slots for isolating the strong current cable and the weak current cable of the communication cables.

According to some embodiments of the present application, as shown in FIG. 5 to FIG. 7, the first plate 21 and/or the second plate 22 is provided with a second positioning member 23 for positioning the communication cable. Specifically, the second positioning member 23 is configured for fixing the communication cable in the second wiring space to prevent the communication cable from playing.

According to some embodiments of the present application, as shown in FIG. 5 to FIG. 7, the second positioning member 23 is located at one side of the second partition plate 24 in a length direction. Specifically, the second positioning member 23 is provided at one side of the second partition plate 24 in the length direction to fix the communication cable in an extension direction of the communication cable, so that the constraint effect on the communication cable is better. Of course, it can be understood that the position of the second positioning member 23 is not limited thereto, for example, the second positioning member 23 may also be provided on the second partition plate 24; or a part of the second positioning member 23 is provided on the second partition plate 24, and another part of the second positioning member 23 is provided at one side of the second partition plate 24 in the length direction, as long as the position of the communication cable can be limited.

In some embodiments, the second wiring assembly 20 includes a first plate 21 and a second plate 22. The first plate 21 is not limited to a sheet metal member being bent, and he first plate 21 needs to be mounted on the second plate 22 by bolts on site. The second plate 22 is not limited to a sheet metal member being bent, the second partition plate 24 is provided in the second plate 22 for isolating weak current cable and strong current cable of the communication cables, and the second positioning part 23 is provided in the second plate 22 for fixing the communication cable and is not limited to be mounted at a top of the cabinet assembly 1 by bolts. Compared with wiring by the round wire conduits in the prior art, the wiring of the communication cable is not limited by the second wiring space.

In some embodiments, the second positioning member 23 includes multiple cable holes and multiple cable ties, where the multiple cable holes may be formed on the second plate 22 and/or the second partition plate 24, and the cable ties for binding the cables respectively run through the corresponding cable holes after the cable is bound, so as to fix the communication cable in the second wiring space, thereby preventing the communication cable from playing.

In some embodiments, the first wiring assembly 10 includes a third plate and a fourth plate. The third plate is fixed to the main body 40; a part of the fourth plate is connected to the third plate, and another part of the fourth plate is located at one side of the third plate, and the first wiring space is located between the third plate and the fourth plate. A partition plate is provided on the third plate to define multiple wiring slots. Compared with wiring by the round wire conduits in the prior art, the wiring of the fire-fighting cable is not limited by the first wiring space. It may be understood that the structure of the first wiring assembly 10 is not limited thereto; the first wiring space may also be defined by bending a sheet metal member, as long as the wiring of the fire-fighting cable is not limited by the first wiring space.

According to some embodiments of the present application, as shown in FIG. 1, the first wiring assembly 10 and the second wiring assembly 20 are both located at a top of the first chamber. Specifically, the first wiring assembly 10 and the second wiring assembly 20 are mounted at the top of the first chamber, to improve the space utilization rate of the first chamber.

In some embodiments, the first wiring assembly 10 is located at a top of the second wiring assembly 20, to further improve the space utilization rate of the first chamber.

According to some embodiments of the present application, the third wiring space is provided close to a corner of a wall of the second chamber. Specifically, the third wiring space is arranged close to the corner of the wall the second chamber, which facilitates the layout of the open wires and the installation of the pipelines on the wall, the neatness of the cabinet assembly 1 can be improved. Moreover, by arranging the third wiring space on the wall, the fire-fighting cable and the communication cable can be routed through the wall, which reduces the space occupied by arranging additional wire conduits and avoids affecting the overall appearance of the cabinet assembly 1.

According to some embodiments of the present application, the main body 40 includes an outer housing and an inner plate. The inner plate is fixed to an inner surface of the outer housing, and the inner plate defines an inner wall of the second chamber; and the third wiring space is defined between the inner plate and the inner surface of the outer housing. Specifically, the inner plate is fixed to the inner surface of the outer housing and is configured as the inner wall of the second chamber, and the inner plate and the inner surface of the outer housing together define the third wiring space. That is to say, the third wiring space is a pre-embedded space, and the inner plate is provided on the inner surface of the outer housing and defines the third wiring space with the outer housing to ensure that the appearance of the cabinet assembly 1 is flat.

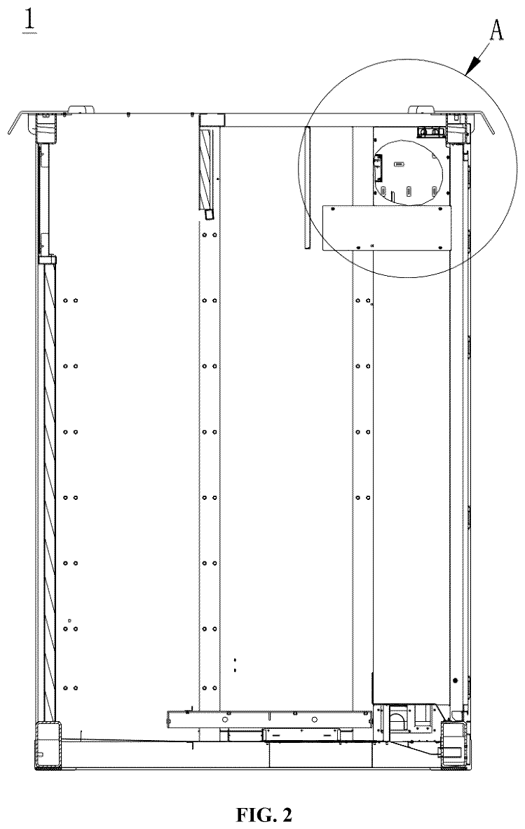

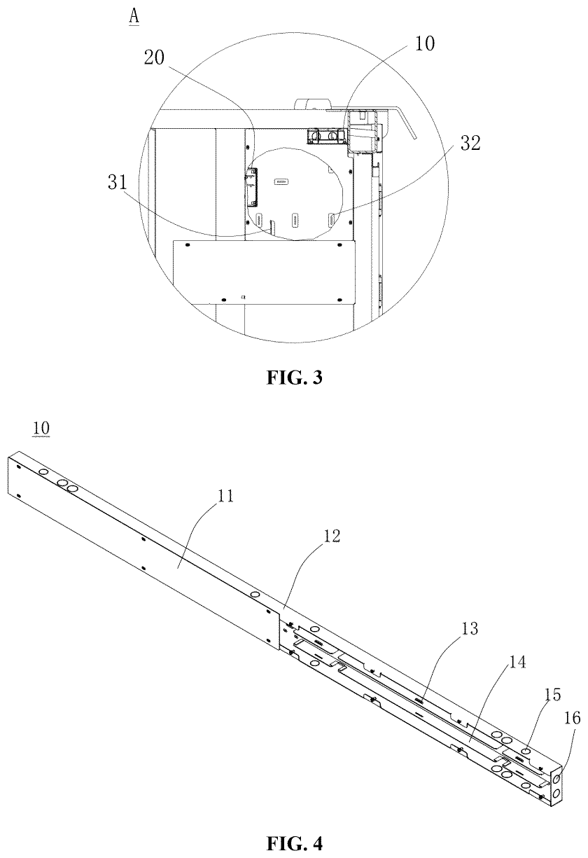

According to some embodiments of the present application, as shown in FIG. 2 and FIG. 3, a third partition plate 31 is provided on the inner surface of the outer housing to define multiple fourth wiring slots. Specifically, the third partition plate 31 is provided on the inner surface of the outer housing to separate the third wiring space into multiple fourth wiring slots for isolating the fire-fighting cable and the communication cable.

According to some embodiments of the present application, as shown in FIG. 2 and FIG. 3, the inner surface of the outer housing is provided with a third positioning member 32 for positioning a cable. Specifically, the third positioning member 32 is suitable to fix the cable in the third wiring space to prevent the cable from playing.

In some embodiments, the third partition plate 31 is welded to the inner wall of the outer housing to separate different types of cables. The inner plate is not limited to a sheet metal member being bent and configured to protect the cables in the multiple fourth wiring slots, thereby ensuring a flat appearance.

In some embodiments, the third positioning member 32 includes multiple cable holes and multiple cable ties. For example, the multiple cable holes are formed in the inner surface of the outer housing, and the multiple cable ties for binding the cables respectively run through the corresponding cable holes after the cable is bound, so as to fix the fire-fighting cable and the communication cable to the inner surface of the outer housing respectively.

It should be noted that the structures of the first positioning member 13, the second positioning member 23 and the third positioning member 32 are not limited to the above embodiments; and each of the first positioning member 13, the second positioning member 23 and the third positioning member 32 may adopt any structures as long as it can be used for positioning the cable. For example, the first positioning member 13 may include a groove and a resilient protrusion provided at an opening of the groove, the cable is located in the groove, and the resilient protrusion is in contact with the cable to limit the cable. It should also be noted that the structures of the first positioning member 13, the second positioning member 23, and the third positioning member 32 may be the same or different, which can be provided according to actual demands.

In some embodiments of the present application, the cabinet assembly 1 includes a main body 40, the first wiring assembly 10 and the second wiring assembly 20. The main body 40 includes an outer housing and an inner plate, an inner partition plate is provided in the outer housing to divide the outer housing into a first chamber and a second chamber. The first wiring assembly 10 and the second wiring assembly 20 are mounted at a top of the first chamber, the inner plate is fixed to an inner surface of the outer housing and is configured as an inner wall of the second chamber, and the inner plate and the inner surface of the outer housing together define a third wiring space. The third wiring space is provided close to a corner of a wall of the second chamber, and a third partition plate 31 is provided on the inner surface of the outer housing to separate the third wiring space into multiple fourth wiring slots, and a third positioning member 32 is provided on the inner surface of the outer housing.

The first wiring assembly 10 includes a first accommodating member 12 and a first covering member 11, where the first accommodating member 12 is fixed to the main body 40 and is provided internally with a first wiring space, the first wiring space is provided with a placement opening, and the first covering member 11 is fitted to the first accommodating member 12 to close the placement opening. A first partition plate 14 is provided in the first accommodating member 12 to separate the first wiring space into a first wiring slot and a second wiring slot, an information transmission part of a fire-fighting cable is provided in the first wiring slot, and a power transmission part of the fire-fighting cable is provided in the second wiring slot. The first wiring space is further provided internally with a first positioning member 13 suitable for positioning the fire-fighting cable. The second wiring assembly 20 includes a first plate 21 and a second plate 22, wherein the first plate 21 is fixed to the main body 40, and at least a part of the second plate 22 is connected to the first plate 21 and defines a second wiring space with the first plate 21. A second partition plate 24 is provided on the first plate 21 to separate the second wiring space into multiple third wiring slots, and a second positioning member 23 is provided on one side of the second partition plate 24 in the length direction.

The cabinet assembly 1 is provided internally with a first wiring slot and a second wiring slot suitable for guiding the wiring of the fire-fighting cable, multiple third wiring slots for guiding the wiring of the communication cable, and multiple fourth wiring slots for guiding the fire-fighting cable and the communication cable respectively. The first wiring slot and the second wiring slot are located in the first wiring assembly 10, the first wiring assembly 10 may be fixedly mounted at a top of the cabinet assembly 1 by bolts. The first wiring assembly 10 is provided internally with a first wiring space, and an installation position for a fire-fighting device is reserved on a surface of the first wiring assembly 10 for fire-fighting wiring, to avoid from additional fire-fighting wire conduits of the cabinet assembly 1, thereby simplifying the overall wiring arrangement. The multiple third wiring slots are located in the second wiring assembly 20, and the second wiring assembly 20 may be mounted at the top of a vertically extending column in an inner decorative plate at the top of the cabinet assembly 1. The second wiring assembly 20 is provided internally with a second wiring space for a communication cable for an electrical component to avoid potential safety hazards caused by the arrangement of the open wire. The multiple fourth wiring slots are arranged at a position for crossing the wall, which facilitates the layout of the open wire and the installation of the lines from the top along the wall, and thus the neatness of the cabinet assembly 1 is improved.

An energy storage apparatus according to the present application is briefly described below.

The energy storage apparatus according to the present application includes: a cabinet assembly 1, an electrical element, a battery, and a fire-fighting device. The cabinet assembly 1 is configured as the cabinet assembly 1 according to any one of the above embodiments; the electrical element is placed in the second chamber; the battery is arranged in the first chamber, and the communication cable connected to the battery is routed along the second wiring space and the third wiring space to be electrically connected to the electrical element; and the fire-fighting device is located in the first chamber, and the fire-fighting cable electrically connected to the fire-fighting device is routed along the first wiring space and the third wiring space to be electrically connected to the electrical element. Specifically, the battery and the fire-fighting device are provided in the first chamber, the electrical element is provided in the second chamber, the fire-fighting cable electrically connects the fire-fighting device with the electrical element through the first wiring space and the third wiring space, and the communication cable electrically connects the battery with the electrical element through the second wiring space and the third wiring space. Since the energy storage apparatus according to the present application has the cabinet assembly 1 of the above embodiment, the overall wire arrangement of the energy storage apparatus is simpler, and the wiring of open wires can be concealed, thereby the risk caused by the failure of the open wires is avoided.

According to some embodiments of the present application, the energy storage apparatus further includes an external power cable, where one end of the external power cable extends out of the second chamber, and the external power cable is routed along the third wiring space to be electrically connected to the electrical element. Specifically, the external power cable is routed to be electrically connected to the electrical element to supply power to the electrical element. Further, the external power cable may extend from a bottom wall of the second chamber to be electrically connected to an external power supply device.

In summary, the first wiring space, the second wiring space and the third wiring space are provided in the cabinet assembly 1 according to the present application, to simplify the overall wire arrangement, such that the concealed wiring of open wires can be realized, to avoid the risks caused by the failure of the open wires. The first wiring space is closed by the first covering member 11, which has a protective effect and maintains the good overall appearance of the cabinet assembly 1. Moreover, the first partition plate 14, the second partition plate 24, and the third partition plate 31 are provided in the first wiring space, the second wiring space, and the third wiring space respectively, to define multiple wiring slots for isolating cables having different functions. The first positioning member 13, the second positioning member 23 and the third positioning member 32 are provided in the first wiring space, the second wiring space and the third wiring space respectively, so as to cooperate with the cable ties to fix the corresponding cables, thereby preventing the cable from playing. Arranging the third wiring space on the wall enables the cable to run through the wall, so as to reduce the space occupied by the additional wire conduit, to avoid affecting the overall appearance of the cabinet assembly 1.

In the description of the present specification, description relating to terms “an embodiment”, “some embodiment”, “an example”, “specific example” and “some examples”, etc. means that a particular feature, structure, material, or characteristic described in conjunction with this embodiment or example is included in at least one embodiment of the application. In this specification, the schematic expressions of the above terms are not necessarily directed to the same embodiments or examples. Furthermore, the specific features, structures, materials or characteristics described may be combined in any one or more embodiments or examples in a suitable manner. In addition, those skilled in the art can incorporate and combine different embodiments or examples described in this specification.

Although the embodiments of the present application have been shown and described above, changes, modifications, substitutions and variations can be made to the above embodiments.

1. A cabinet assembly of an energy storage apparatus, comprising:
a main body, wherein a first chamber configured for accommodating a battery and a second chamber configured for accommodating an electrical element are provided in the main body;
a first wiring assembly, which is fixed to an inner wall of the main body, a first wiring space for guiding wiring of a fire-fighting cable is provided in the first wiring assembly, the first wiring space is provided with a first wiring hole located in the first chamber, and the fire-fighting cable is configured to be electrically connected to a fire-fighting device through the first wiring hole;
a second wiring assembly, which is fixed to the inner wall of the main body, and a second wiring space, for guiding wiring of a communication cable configured to be electrically connected to the battery, is provided in the second wiring assembly;
a third wiring space, which is located in the second chamber, wherein the first wiring space and the second wiring space are respectively in communication with the third wiring space, and the fire-fighting cable and the communication cable are configured to be respectively electrically connected to the electrical element.

2. The cabinet assembly of the energy storage apparatus according to claim 1, wherein the first wiring assembly comprises:
a first accommodating member, wherein the first wiring space having a placement opening is located in the first accommodating member, the fire-fighting cable is configured to be placed in the first wiring space through the placement opening, and the first accommodating member is fixed to the main body; and
a first covering member, which is arranged at the first accommodating member to cover the placement opening.

3. The cabinet assembly of the energy storage apparatus according to claim 2, wherein a first partition plate is provided in the first accommodating member to define a first wiring slot and a second wiring slot, wherein the first wiring slot is configured for placing an information transmission part of the fire-fighting cable, and the second wiring slot is configured for placing a power transmission part of the fire-fighting cable.

4. The cabinet assembly of the energy storage apparatus according to claim 1, wherein a first positioning member for positioning the fire-fighting cable is provided in the first wiring space.

5. The cabinet assembly of the energy storage apparatus according to claim 1, wherein the second wiring assembly comprises:
a first plate, which is fixed to the main body;
a second plate, wherein a part of the second plate is connected to the first plate, another part of the second plate is located at one side of the first plate, and the second wiring space is located between the first plate and the second plate.

6. The cabinet assembly of the energy storage apparatus according to claim 5, wherein a second partition plate is provided on the first plate to define a plurality of third wiring slots.

7. The cabinet assembly of the energy storage apparatus according to claim 6, wherein the first plate and/or the second plate is provided with a second positioning member for positioning the communication cable.

8. The cabinet assembly of the energy storage apparatus according to claim 7, wherein the second positioning member is located at one side of the second partition plate in a length direction.

9. The cabinet assembly of the energy storage apparatus according to claim 1, wherein the first wiring assembly and the second wiring assembly are both located at a top of the first chamber.

10. The cabinet assembly of the energy storage apparatus according to claim 1, wherein the third wiring space is located close to a corner of a wall of the second chamber.

11. The cabinet assembly of the energy storage apparatus according to claim 1, wherein the main body comprises:
an outer housing; and
an inner plate, which is fixed to an inner surface of the outer housing, wherein the inner plate defines an inner wall of the second chamber, and the third wiring space is defined between the inner plate and the inner surface of the outer housing.

12. The cabinet assembly of the energy storage apparatus according to claim 11, wherein a third partition plate is provided on the inner surface of the outer housing to define a plurality of fourth wiring slots.

13. The cabinet assembly of the energy storage apparatus according to claim 11, wherein the inner surface of the outer housing is provided with a third positioning member for positioning a cable.

14. An energy storage apparatus, comprising:
a cabinet assembly, which is the cabinet assembly according to claim 1;
an electrical element, which is placed in the second chamber;
a battery, which is located in the first chamber, wherein the communication cable which is connected to the battery is routed along the second wiring space and the third wiring space to be electrically connected to the electrical element;
a fire-fighting device, which is located in the first chamber, wherein the fire-fighting cable electrically connected to the fire-fighting device is routed along the first wiring space and the third wiring space to be electrically connected to the electrical element.

15. The energy storage apparatus according to claim 14, further comprising an external power cable, wherein one end of the external power cable extends out of the second chamber, and the external power cable is routed along the third wiring space to be electrically connected to the electrical element.

16. The cabinet assembly of the energy storage apparatus according to claim 2, wherein the main body comprises:
an outer housing; and
an inner plate, which is fixed to an inner surface of the outer housing, wherein the inner plate defines an inner wall of the second chamber, and the third wiring space is defined between the inner plate and the inner surface of the outer housing.

17. The cabinet assembly of the energy storage apparatus according to claim 3, wherein the main body comprises:
an outer housing; and
an inner plate, which is fixed to an inner surface of the outer housing, wherein the inner plate defines an inner wall of the second chamber, and the third wiring space is defined between the inner plate and the inner surface of the outer housing.

18. An energy storage apparatus, comprising:
a cabinet assembly, which is the cabinet assembly according to claim 2;
an electrical element, which is placed in the second chamber;
a battery, which is located in the first chamber, wherein the communication cable which is connected to the battery is routed along the second wiring space and the third wiring space to be electrically connected to the electrical element;
a fire-fighting device, which is located in the first chamber, wherein the fire-fighting cable electrically connected to the fire-fighting device is routed along the first wiring space and the third wiring space to be electrically connected to the electrical element.
